(19) United States
(12) Patent Application Publication
(10) Pub. No.: US 2018/0101862 A1
(43) Pub. Date: Apr. 12, 2018

(54) SYSTEM AND METHOD FOR PROVIDING AN ADVERTISEMENT IN AN INTERACTIVE ENVIRONMENT

(71) Applicant: Roberto Ronquillo, Quezon City (PH)

(72) Inventor: Roberto Ronquillo, Quezon City (PH)

(21) Appl. No.: 15/573,481

(22) PCT Filed: May 15, 2015
(86) PCT No.: PCT/IB2015/053584

§ 371 Date: Nov. 13, 2017

(51) Int. Cl. G06Q 30/02; A63F 13/61; A63F 13/80; A63F 13/52

(52) U.S. Cl. CPC G06Q 30/0246; G06Q 30/0277; G06Q 30/0267; H04L 63/0861; A63F 13/80; A63F 13/52; A63F 13/61

(57) ABSTRACT

A system for providing an advertisement in an interactive environment is provided. The system comprises a database for identifying and storing datasets representing advertisements, quantitative metrics, and a virtual game environment. Representations of the datasets are rendered on a user interface of a communication device by a processor based on user interaction data. An access to the virtual game environment having an indicia indicative of a real-world prize is provided by the processor based on a value associated with one of the datasets representing the quantitative metrics indicative of a measure of one of the user interaction data. The indicia can be attributed to a user account stored in the database based on another user interaction data that the processor receives from the communication device through the user interface on which the virtual game environment is rendered.

### CROSS-REFERENCE TO RELATED APPLICATIONS

NONE

### FEDERALLY SPONSORED RESEARCH

NOT APPLICABLE

### SEQUENCE LISTING OR PROGRAM

NOT APPLICABLE

### TECHNICAL FIELD

The present invention relates to a system and method for providing electronic advertisements to communication devices but more particularly to such a system and method implemented in an interactive environment by one or more computers based on user interaction data.

### BACKGROUND ART

Consumers are exposed to advertisements from time to time, either through broadcast commercials, print ads, email ad campaigns, pop-up ads on web browsing applications, or even through in-app mobile ads. These forms of advertisements are supposed to function such that, the advertisements capture the consumers' attentions, the consumers' attentions on the advertisements are retained, and the consumers are ultimately persuaded to patronize the advertised goods and/or services of advertisers. The alarming reality on the part of the advertisers however is that, consumers are commonly predisposed to ignore advertisements no matter how attractive they are due to a mixture of reasons. For one, the mechanism by which the advertisements are presented to the consumers does not enable the consumers to interact with the advertisements.

In United States Patent Publication No. 20120094764 published on 19 Apr. 2012 to Webuxx, LLC (MI, USA), disclosed is a web-based advertisement and sweepstakes system which allows users willing to interact with online advertisements to participate in free sweepstakes with the chance to win prizes. The web-based system may display advertisements, manage sweepstakes information, and apply sweepstakes rules to information received from participants in order to determine sweepstakes results. Further disclosed in this prior art system is that sweepstakes entry requirements can include displaying an advertisement for a preset length of time, providing user feedback in connection with a particular advertisement, and clicking or otherwise interacting with the interface generally—or with the advertisement itself—in response to prompting the participant with sweepstakes information.

While the sweepstakes entry requirements employed in the above cited prior art system arguably provide the mechanism by which consumers can interact with the advertisements, there remains a problem associated with the mechanism by which the sweepstakes are operated in the same prior art system. Specifically, the prior art system determines the sweepstakes result on the basis of a sequential ordering of participant information by way of assigning a unique entry number to each participant at the time of receipt of the participant information. In determining the sweepstakes outcome, i.e., winning or losing outcome, the prior art system compares the participant's unique entry number with a preset number contained within the sweepstakes rules. If the participant's unique entry number matches the preset number, the system adjudges the participant a winner and the sweepstakes result is a winning outcome. If, on the other hand, the participant's unique entry number does not match the preset number, the system adjudges the participant a loser and the sweepstakes result is a losing outcome.

The problem associated with the cited prior art system is that its mechanism by which the sweepstakes are made operable is a potential source of fraud. Since the sequential ordering of the participant information on which the generation of the unique entry number rely may be altered maliciously without reference to any legitimate participant information known to the participant, the determination of the sweepstakes outcome which depends on the unique entry number may not be reliable and is questionable, highly arbitrary and not readily verifiable on the part of the participant. This creates doubts on the veracity of the sweepstakes operation which, in turn, may affect the reputation of the advertisers represented by the advertisements or of service providers and publishers providing the prior art system.

Thus, there remains an outstanding need to provide at least a system for providing an advertisement in an interactive environment implemented by one or more computers, wherein use of electronic data associated with the users' interactions with said computers is least likely susceptible to fraud.

### SUMMARY OF THE INVENTION

In one aspect of the invention, a computer-implemented system for providing an advertisement in an interactive environment based on user interaction data is provided. The system includes a database for identifying and storing a plurality of datasets, a processor in operative communication with the database and arranged to render representations of the plurality of datasets from the database on a user interface of a communication device, and computer-executable instructions stored on a computer-readable medium in operative communication with the processor.

The computer-executable instructions, when executed by the processor from the computer-readable medium, are arranged to obtain a first dataset associated with the plurality of datasets. The first dataset represents an advertisement associated with the plurality of advertisements from the database when the system receives a first user interaction data from the communication device through the user interface. By this representation, the first dataset is rendered on the user interface of the communication device.

The executed computer-executable instructions are further arranged to generate and store into the database a second dataset associated with the plurality of datasets. The second dataset represents quantitative metrics indicative of a measure of a second user interaction data that the processor receives from the communication device through the user interface on which the representation of the first dataset is rendered.

The executed computer-executable instructions also provide an access to a third dataset associated with the plurality of datasets. The third dataset represents a virtual game environment based on a value associated with the second dataset and has an indicia indicative of a real-world prize. The indicia can be attributed to a user account stored in the database based on third user interaction data that the processor receives from the communication device through the user interface on which a representation of the third dataset is rendered.

Preferably, the value associated with the second dataset representing the quantitative metrics corresponds to a total number of advertisements that are opened through the user interface on which the representation of the first dataset is rendered. Alternatively, the value associated with the second dataset representing the quantitative metrics corresponds to a total number of clickable links in one or more of the advertisements clicked on the user interface on which the representation of the first dataset is rendered.

The provision of the system providing an access to the virtual game environment represented by the third dataset based on the aforesaid value associated with the second dataset ensures that the user interaction data are continued to be received by the processor from the communication device. In particular, the access to the virtual game environment enables a user of the communication device to engage with a virtual gameplay which may be based on the total of number of advertisements opened or clicked by the user through the user interface of the communication device. This ensures that the user can be encouraged and motivated to view more advertisements or effect more interactions relative to the user interface on which the advertisement is displayed since the number of views or clicks that the user can effect on the user interface may be directly proportional to the number of times that the user can access the virtual game of chance and engage with gameplays.

The motivation of the user may be guaranteed since the gameplay with which the same user can engage is preferably a virtual game of chance which is arranged to provide the user account associated with the user with the chance to be attributed of the indicia that is indicative of the real-world prize. The attribution of the indicia to the user account means that the user to which the user account belongs wins the real-world prize associated with the indicia.

The provision of the system providing the attribution of the indicia to the user account based on the third user interaction data, which preferably correspond to a combination of numbers designated by the user in the game of chance characterized by a lottery, ensures that the lottery operation is least likely to be a potential source of fraud. This is so because the combination of numbers on which a lottery draw could be based is designated by the user which, in turn, means that the same user has a record or basis for determining by himself/herself as to whether he/she validly wins in the lottery draw.

In other words, the determination of an outcome of the lottery which depends, in part, on the combination of numbers designated by the user is reliable and is least likely to be deemed questionable and arbitrary. There is also a small chance of fraud occurring since the question of whether the user wins or not is readily verifiable on his/her part. In effect, the operation governing the potential awarding of the real-world prize, such as a cash prize, to the user based on his/her interactions with the advertisements and with the virtual game environment can be regarded as credible and trustworthy.

In another aspect of the invention, a computer-implemented method for providing an advertisement in an interactive environment based on user interaction data is provided. A first step of the method is characterized by obtaining a first dataset representing an advertisement from a database in response to first user interaction data received from a communication device through a user interface of the communication device, wherein a representation of the first dataset is rendered on the user interface of the communication device.

The second step of the method is characterized by generating and storing into the database a second dataset representing quantitative metrics indicative of a measure of second user interaction data received from the communication device through the user interface on which the representation of the first dataset is rendered.

A third step of the method is directed to providing an access to a third dataset representing a virtual game environment based on a value associated with the second dataset, wherein the third dataset has an indicia indicative of a real-world prize.

A fourth step of the method is the attribution of the indicia to a user account stored in the database based on third user interaction data received from the communication device through the user interface on which a representation of the third dataset is rendered.

The step of attributing the indicia to the user account may be based further on an outcome of a virtual game of chance included in the virtual game environment represented by the third dataset. The method may also include the step of determining the outcome of the virtual game of chance based on a fourth dataset derived from a conduct of a real-world game of chance equivalent to the virtual game of chance.

For a better understanding of the invention and to show how the same may be performed, preferred embodiments thereof will now be described, by way of non-limiting examples only, with reference to the accompanying drawings.

### BRIEF DESCRIPTION OF THE DRAWINGS

FIG. 1 is a schematic block diagram illustrating a system for providing an advertisement in an interactive environment according to one aspect of the invention.

FIG. 2 is a block diagram of software modules suitable for use in the system of FIG. 1.

FIG. 3 is a general flow diagram for providing an advertisement suitable use in the system of FIG. 1.

FIG. 4 is a flow diagram illustrating an interaction of the components of the system of FIG. 1.

FIG. 5 is a flow diagram illustrating a process for detecting an event suitable for use in the flow of FIG. 3.

FIG. 6 is a block diagram of components of an electronic lottery ticket of FIG. 5.

FIG. 7 is a flow diagram of a process for accessing a virtual game environment suitable for use in the system of FIG. 1.

FIG. 8 is a continuation of the flow diagram of FIG. 7.

FIG. 9 is a flow diagram illustrating a process for conducting an electronic lottery draw suitable for use in the system of FIG. 1.

FIG. 10 is a flow diagram illustrating a process for applying a winning eligibility criterion suitable for use in the system of FIG. 1.

FIG. 11 is a block diagram illustrating an alternative system for providing an advertisement in an interactive environment.

FIG. 12 is a hardware architecture suitable for use in the systems of FIGS. 1 and 11.

FIG. 13 is a block diagram of database content suitable for use in the systems of FIGS. 1 and 11.

### DETAILED DESCRIPTION OF PREFERRED EMBODIMENTS

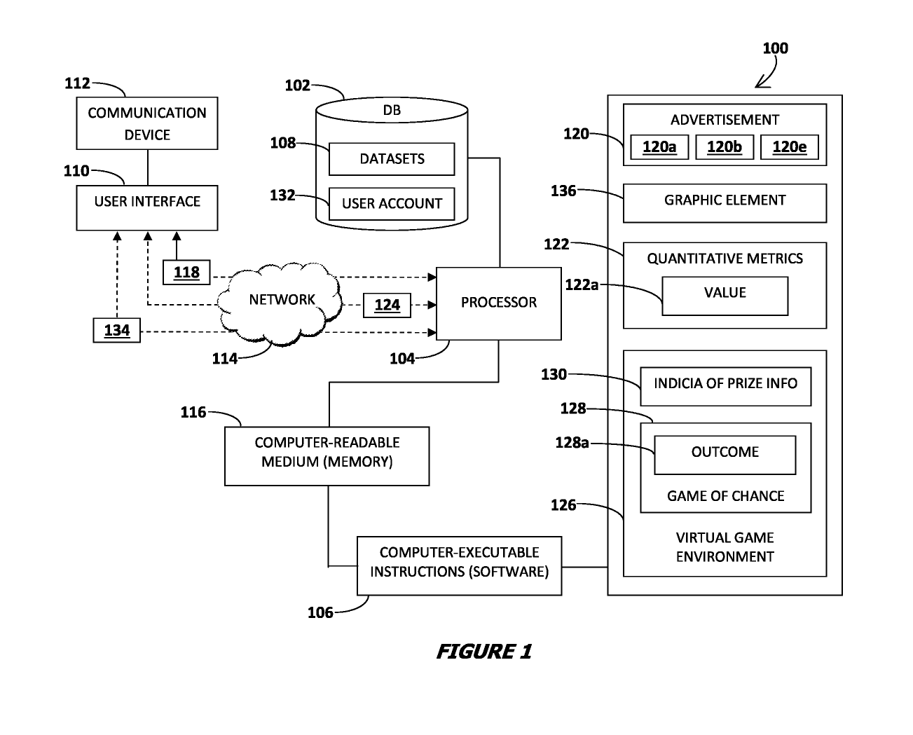

Referring to FIG. 1, there is shown a schematic block diagram illustrating a system for providing an advertisement in an interactive environment according to one aspect of the present invention. The system is consistently designated by reference numeral 100 throughout the ensuing description. The system 100 mainly includes a database 102, a processor 104, and computer-executable instructions 106.

The database 102, which may be a relational database, an object database, or a data warehouse, is arranged to receive, process, store, and identify a plurality of datasets 108. The database 102 is preferably arranged to operatively work in conjunction with a relational database management system (RDBMS) and is preferably of the type that can be queried using a structured query language (SQL) or any other suitable query language. In one embodiment, a JDO Query language (JDOQL) for Java Data Objects (JDO) may be suitably employed in the system 100 of the present invention for flexibility in retrieving database objects, which may comprise the plurality of datasets 108, that meet a certain and predetermined set of criteria. It is to be understood and appreciated by a person skilled in the art to which the present invention belongs that two or more databases of the type similar to the database 102 may be implemented in the system 100 of the present invention.

The processor 104 is in operative communication with the database 102 and is arranged to render representations of the plurality of datasets 108 from the database 102 on a user interface 110 of a communication device 112. The processor 104 may be a commercially available general processor, a custom general processor, a special-purpose processor, or an embedded processor. The processor 104 may also be implemented as a multi-core processor such as a coprocessor having a significant number of cores available. The processor 104 may be embodied by a single data processing device or combinations of multiple data processing devices connected to a communication network 114, as illustrated, a cloud computing network, or a distributed processing network.

The computer-executable instructions 106 are stored on a computer-readable medium 116 that is in operative communication with the processor 104. For brevity, the computer-executable instructions 106 are hereinafter referred to as “software,” and the computer-readable medium 116 as “memory.” The software 106 may be executed by the processor 104 as machine codes in a direct manner or as scripts in an indirect manner, and may be stored on the computer-readable medium 116 as source codes, object codes, or any other suitable computer-readable format. The software 106 may include a set of routines, a set of functions, a set of modules, a set of scripts, a set of processes, or the like, each of which may be composed using any suitable programming language such as C, C++, Java, Javascript, C#, Perl, and the like.

The memory 116 may be one of or a combination of any of a random access memory, a read-only memory, a flash memory, an external memory, a hard drive storage device, an optical disk drive storage device, a magnetic disk drive storage device, and a solid state drive storage device. It is to be understood and appreciated that, while the software 106 is embodied to be stored on the memory 116, the same software 106 may be desirably loaded directly on the processor 104. It is also to be understood and appreciated that one or more components or the entire components of the software 106 may be localized on a single computing device, as characterized by the processor 104, or distributed across multiple computing devices in communication with one another through wired or wireless connections.

The software 106, when executed by the processor 104 from the computer-readable medium 116, is arranged to obtain a first dataset associated with the plurality of datasets 108 from the database 102 in response to first user interaction data 118 received from the communication device 112 through the user interface 110. The first user interaction data 118 is preferably received by the processor 104 from the communication device 112 over the communication network 114.

The communication network 114 may include one or more networks interlinked together so as to provide internetworked communications between computing devices such as that characterized by the processor 104. One or more public or private packet-switched networks may also characterize the communication network 114. Preferably, the communication network 114 may include the public Internet. Alternatively, the communication network 114 may include one or more Ethernet connections or similar private connections utilizing the Transmission Control Protocol/Internet Protocol (TCP/IP), among others.

The processor 104 is arranged to render representations of the plurality of datasets 108 from the database 102 on the user interface 110 of the communication device 112 over the communication network 114. Thus, a representation of the first dataset, which generally represents an advertisement 120, is rendered on the user interface 110 of the communication device 112 when the first dataset is obtained from the database 102 by the processor 104 in response to the first user interaction data 118 received by the processor 104 from the communication device 112 through the user interface 110 over the communication network 114.

The software 106, when executed by the processor 104 from the computer-readable medium 116, is further arranged to generate and store into the database 102 a second dataset associated with the plurality of datasets 108. The second dataset represents quantitative metrics 122 which are indicative of one or more measures of second user interaction data 124 received by the processor 104 from the communication device 112 through the user interface 110 on which the representation of the first dataset is rendered.

The software 106, when executed by the processor 104 from the computer-readable medium 116, is further arranged to provide an access to a third dataset associated with the plurality of datasets 108. The third dataset represents a virtual game environment 126 through which a virtual game of chance 128 can be initialized and played by a user operating the communication device 112 through the user interface 108 over the communication network 114.

The access to the third dataset associated with the plurality of datasets 108 may be based on a value 122a associated with the second dataset and has an indicia 130 that is indicative of a real-world prize or any information representing or pertinent to the real-world prize. The indicia 130 can be attributed to a user account 132 stored in the database 102 based on third user interaction data 134 that the processor 104 receives from the communication device 112 over the communication network 114 and through the user interface 110 on which a representation of the third dataset is rendered.

Preferably, the value 122a associated with the second dataset representing the quantitative metrics 122 corresponds to a total number of advertisements 120a, 120c, 120e that are opened through the user interface 110 on which the representation of the first dataset is rendered. Alternatively, the value 122a associated with the second dataset representing the quantitative metrics 122 corresponds to a total number of clickable links in one or more of the advertisements 120a, 120c, 120e clicked on the user interface 110 on which the representation of the first dataset is rendered.

Preferably, each of the clickable links may be embedded on the advertisement 120 generally represented by the first dataset. Alternatively, each of the clickable links may be embedded on a graphic element 136 corresponding to the first dataset rendered on the user interface 110. The graphic element 136 may be a still image or a moving image. A notable feature of the system 100 of the present invention is that the graphic element 136 is configured to be moveable within an area of the user interface 110 defined by the first dataset rendered on the user interface 110.

The software 106 may be arranged such that a movement of the graphic element 136 from one portion of the area of the user interface 110 to another causes change in the advertisement 120 (e.g., from the advertisement 120a to the advertisement 120c, from the advertisement 120c to the advertisement 120e, etc.) represented on the user interface 110 by the first dataset generally representing the advertisement 120. The software 106 may also be arranged such that the graphic element 136 is configured to appear on the user interface 110 on which the representation of the first dataset is rendered after a predetermined time period (e.g., 5 seconds, 10, seconds, 15 seconds, etc.) for each change in the advertisement 120 (e.g., from the advertisement 120a to the advertisement 120c, from the advertisement 120c to the advertisement 120e, etc.).

The above described preferred arrangements for the presentation of the graphic element 136 on the user interface 110 ensures that the advertisement 120, in general, is likely to be viewed by the user since an interaction relative to the user interface on which the advertisement 120 is displayed is required to be effected by the user. Stated otherwise, if the user does not interact with the advertisement 120 rendered or displayed on the user interface 110 of the communication device 112 by way of moving the graphic element 136, then he/she cannot move to another advertisement. Without such interaction, no point or token (characterized by the value 122a associated with the second dataset representing the quantitative metrics 122) can be earned by the user or can be attributed to the user account 132 of the user. In that case, no access to the virtual game environment 126 can be provided to the communication device 112 operable by the user, effectively losing his/her chance to engage with any gameplay associated with the game of chance 128 and win a cash prize based on an outcome 128a of the game of chance 128.

It is to be understood and appreciated that the quantitative metrics 122 that can be measured by the software 106 may also include any of the following: (i) time spent on the user interface 110 displaying each of the advertisements 120a, 120c, and 120e; (ii) rate of completing an action or a task such as swiping, tapping, scrolling, long-pressing, touching, multi-touching, pinching, reverse pinching, pecking, dragging, tilting, flicking, and holding within a predetermined time period; (iii) total number of advertisements 120a, 120c, and 120e shared outside the system 100 such as through social media platforms like Facebook™ and Twitter™, email applications, and calendar applications; (iv) total number of questions answered through the user interface 110; and (v) average number of events detected by one of the components of the system 100 such as downloading of local copies of any one or more of the advertisements 120a, 120c, and 120e into the communication device 112.

In order for the processor 104 to transmit the electronic data, which include the first dataset, the second dataset, the third dataset, the first user interaction data 118, the second user interaction data 124, and the third user interaction data 134, to and from the communication device 112, a communication interface (not illustrated) may be provided in the system 100 and arranged in communication with the processor 104. The communication interface may include logic which enables routing of one or more of or the entire components of the software to and from the communication device 112.

It is to be understood and appreciated that the software 106, in part or as a whole, may be presented as a local application, a web-based client application, and/or a mobile-based client application to ensure its availability and accessibility from various computing devices such as mainframe computers, desktop computers, laptop computers, notebook computers, tablet computers, and smartphones characterizing the communication device 112 and having the capability to connect with other computing devices through the communication network 114. As a local application, the software 106, in part or as a whole, may be accessed on a stand-alone gaming machine, regardless of whether or not it is connected to the communication network 114.

The provision of the system providing an access to the virtual game environment 126 represented by the third dataset based on the value 122a associated with the second dataset ensures that the user interaction data, which include the first user interaction data 118, the second user interaction data 124, and the third user interaction data 134, are continued to be received from the communication device 112 by the processor 104 on which the software 106 resides, particularly on the memory 116 of the processor 104.

In particular, the access to the virtual game environment 126 enables the user of the communication device 112 to engage with a virtual gameplay which may be based on the total of number of advertisements 120a, 120c, 120e opened or clicked by the user through the user interface 110 of the communication device 112. This ensures that the user can be encouraged and motivated to view more of such advertisements 120a, 120c, 120e or effect more interaction relative to the user interface 110 on which the advertisement 120, in general, is displayed since the number of views or clicks that the user can effect on the user interface 110 may be arranged in the software 106 to be directly proportional to the number of times that the user can access the virtual game of chance 128 and engage with gameplays.

The motivation of the user may be guaranteed since the gameplay with which the same user can engage is the virtual game of chance 128 that is arranged to provide the user account 132 associated with the user with the chance to be attributed of the indicia 130 indicative of the real-world prize. The attribution of the indicia 130 to the user account 132 means that the user to which the same user account 132 belongs wins the real-world prize associated with the indicia 130. The indicia 130 may be a virtual mark or label which shows prize information such as, for example, 1,000,000.00 Philippine Peso or about 22,460.00 U.S. Dollars.

The provision of the system 100 providing the attribution of the indicia 130 to the user account 132 based on the third user interaction data 134, which preferably correspond to a combination of numbers designated by the user in the virtual game of chance 128 characterized by a lottery according to one embodiment, ensures that the lottery operation is least likely to be a potential source of fraud. This is so because the combination of numbers on which a lottery draw could be based is designated by the user which, in turn, means that the same user has a record or basis for determining by himself/herself as to whether he/she validly wins in the lottery draw.

In other words, the determination of the outcome 128a of the lottery which depends, in part, on the combination of numbers designated by the user is reliable and is least likely to be deemed questionable and arbitrary. There is also a small chance of fraud occurring since the question of whether the user wins or not is readily verifiable on his/her part. In effect, the operation governing the potential awarding of the real-world prize, such as a cash prize, to the user based on his interactions with the advertisements and with the virtual game environment 126 can be regarded as credible and trustworthy.

Likelihood of fraud in the use of the first, second and third user interaction data 118, 124, and 134 can be prevented further since it is preferable that the indicia 130 can be attributed to the user account 132 owned by the user based further on the outcome 128a of the virtual game of chance 128 which is determined based on a fourth dataset associated with the plurality of datasets 108 and introduced into the system 100 from a conduct of a real-world game of chance equivalent to the virtual game of chance 128. The fourth dataset may correspond to a winning number combination drawn for a real-world game of chance equivalent to the virtual game of chance 128.

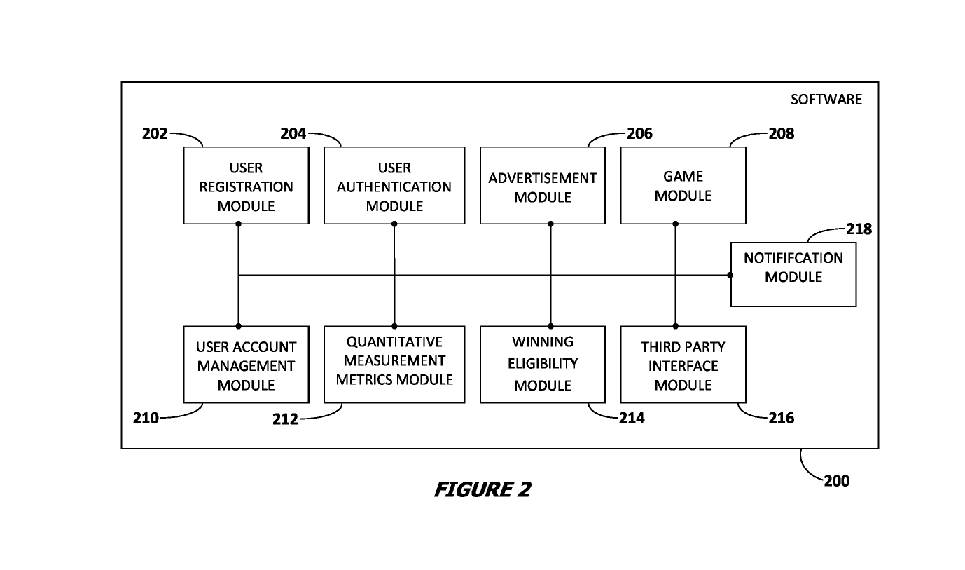

Referring now to FIG. 2, there is shown a block diagram of modules of software 200 suitable for use in the system of FIG. 1 according to one or more embodiments of the present invention. The software 200 preferably includes a user registration module 202, a user authentication module 204, an advertisement module 206, a game module 208, a user account management module 210, a quantitative metrics measurement module 212, a winning eligibility module 214, a third party interface module 216, and a notification module 218.

The user registration module 202 may include software codes for creating user accounts internal to the system for providing an advertisement in an interactive environment according to one or more embodiments of the present invention. The user registration module 202 is preferably configured to receive user information associated with the user of the software. The user information that can be received and processed by the user registration module 202 may serve to identify the user of the software 200. The user information may be confidential in nature. Hence, use and implementation of the software 200 may be governed by user agreements and policies on privacy of information.

Identifiers associated with the user information may include, by way of examples, electronic mail (email) address, first name information, last name information, date of birth information, physical address information, age information, gender information, password information, secret/security question information, telephone number information, mobile number information, and referral code information. Other types of information may be collected by the user registration module 202 which will be apparent in the ensuing description. These other types of information may be associated with the personal profile of the user in terms of his/her level as a viewer of advertisements.

The user authentication module 204 may include software codes for analyzing and validating user information in respect of those collected through the user registration module 202 for each instance the user is required to re-enter his/her user information or otherwise known as login user credential information. Such instance may be, by way of examples, when a communication device on which the software 200 is installed crashes or is reset to a factory mode and when a critical task or action is required to be carried out by the user relative to the implementation of the software 200.

In addition to the user information associated with the user registration module 202, the user authentication module 204 may also collect auxiliary user information such as user finger characteristics information, user hand characteristics information, user palm characteristics information, user face characteristics information, and user eyes characteristics information, among others. These information are stored into the database by the user authentication module 204, and may be used for the purpose of authenticating the user desiring to use or access the software 200 in a highly secure manner. For each attempt by the user to access the software 200 or to perform a critical task or action affecting the software 200, the user authentication module 204 may be initialized by the software 200 to compare the input data of the user with those stored in the database and perform matching of said data.

For example, if software 200 determines that the input data of the user is the hand characteristics information, then the user authentication module 204 is triggered to determine whether the corresponding hand characteristics information stored in the database is matching with the inputted hand characteristics information. The authentication succeeds and the user is thereafter permitted to access the resources associated with the software 200 if and when the two hand characteristics information match one another. On the other hand, the authentication fails and the user is thereafter denied an access to the resources of the software 200 if and when the two hand characteristics information do not match one another.

The advertisement module 206 may include software codes, primarily, for displaying a data stream of advertisements on various communication or computing devices in response to user interaction data received from the same communication or computing devices. The data stream of advertisements, as provided by the advertisement module 206 may include multimedia content such as, but not limited to, text content, image content, video content, audio content, active links, and the like. The advertisement module 206 may be arranged to repeatedly or regularly modify the attributes of any of the advertisements such as their sizes depending on the characteristics of the user interfaces of the communication or computing devices, their relevance in accordance with geographical information associated with the communication devices displaying the advertisements, and their context relevance based on the personal information or activity information associated with the user of the software 200, to name but a few.

The game module 208 may include software codes for displaying a virtual game environment on various communication or computing devices in response to user interaction data received from the same devices. The virtual game environment may include a selection of games characterized by games of chances, the most popular of which is the lottery type. The game module 208 may also perform determination of outcomes associated with the games of chances in accordance with preset outcome determining criteria. For the lottery type, the game module 208 may be arranged to allow manual selection of numbers serving as lottery entries or include a random number generator for automatic generation of combinations of numbers based on requests from the communication or computing devices.

The user account management module 210 may include software codes for creating, maintaining, and managing user accounts created by users. Data from any one or more of other modules of the software 200 may be taken into consideration by the user account management module 210. These data may be particularly useful for performing predetermined tasks such as determining user account ratings, receiving and acknowledging reports made through user accounts like reports associated with potential fraud and complaints, receiving and acknowledging questions made through the user accounts, and issuing responses based on such reports and questions. Every user activity data or user interaction data may be recorded by the user account management module 210.

The quantitative metrics measurement module 212 may include software codes for measuring a numerical degree by which a user interaction data possesses a given attribute. For example, the measurement of the user interaction data may be based on the numbers of clicks effected against a stream of advertisements. The quantitative metrics fully described in FIG. 1 which include, for example, time spent on the user interface displaying advertisements and rate of completing an action or a task such as swiping, tapping, etc., may be managed by the quantitative metrics measurement module 212.

The winning eligibility module 214 defines the criteria by which a user account may qualify to earn value (i.e., points) associated with the user interaction data. The winning eligibility module 214 may be arranged to assign one particular level to a user account depending upon the aforesaid criteria associated with it and based on a multi-level quantization of winning and/or earning qualifications. For example, higher levels may be assigned to the user accounts if electronic declarations concerning the financial capabilities of users operating the user accounts are made by the users through the winning eligibility module 214.

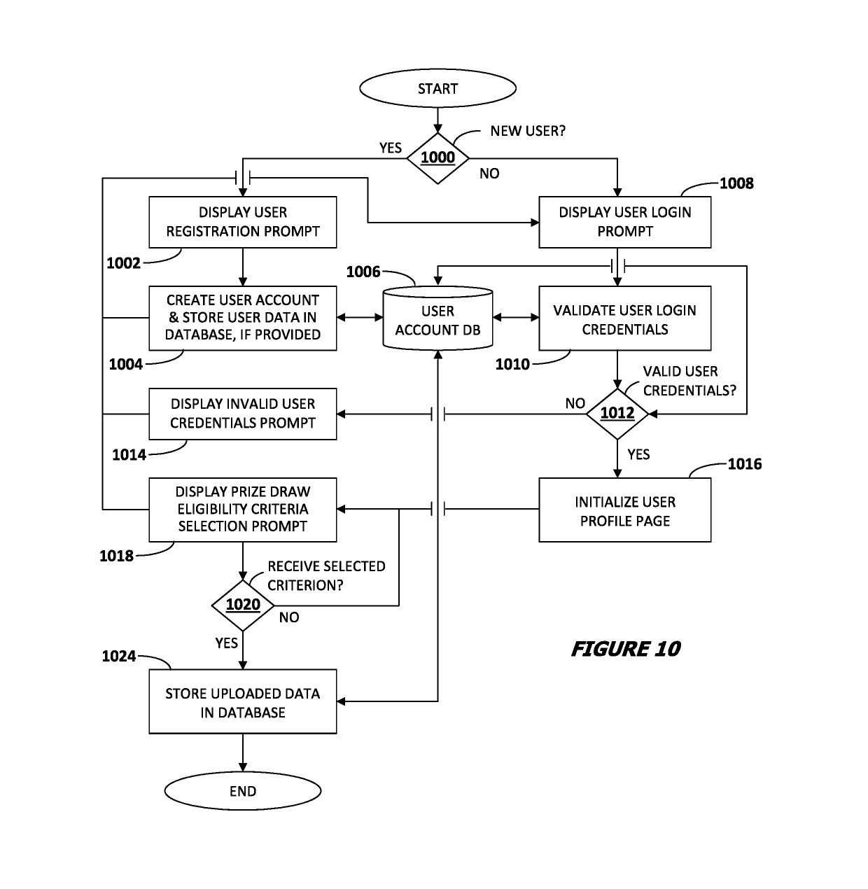

In one embodiment, profiles of users through their user accounts may be edited by the users for effecting the aforesaid electronic declarations, the detailed mechanism for which will be described in greater detail in FIG. 10 below. In another embodiment, the levels of the user accounts are quantified by the number of virtual chips or coins that the users operating the user accounts may earn in various ways. For example, the user may earn the chips or coins by interacting with specific advertisements or by playing auxiliary games (i.e., mini-games) in the virtual environment described in FIG. 1. These chips or coins can then be used by the user to bet on, for example, a Hi-Lo game of chance in the virtual game environment and consequently obtain a chance to win a real-world prize. Alternatively, the user may utilize the chips or coins for exchanging them into real-world items if they reach or go up to a certain level as determined by the winning eligibility module 214.

The third party interface module 216 enables the processor of the system described in FIG. 1 to interact with third party services provided by third party service providers through suitable application programming interfaces (APIs). Examples of such third party services that can be provided by the third party service providers through the third party interface module 216 may include social media platforms such as Facebook™, Google™ and Twitter™, advertising applications, gaming applications, Google™ analytics, verification/authentication applications, and email communication applications, to name a few.

The notification module 218 provides customizable mechanisms for generating notifications to various communication devices. Examples of such mechanisms may include email notifications through an IP/TCP network, short message service (SMS) notifications through a telecommunications network, pop-up alerts on user interfaces and interactive pages, and the like. Various events may trigger the notification module 218 to send notifications in any suitable form. These events may include, for example, when an unauthorized access to a user account is detected, when unauthorized changes in user information are identified, when a lottery draw date information is determined to be approaching a preset draw date information, when a winning number combination is electronically drawn, and when an indicia of a prize information is attributed to any user account.

It is to be understood and appreciated that the illustrated software modules 200 of the system for providing an advertisement in an interactive environment of the present invention may or may not correspond to discrete blocks of software codes, depending on how they are arranged. In this regard, it can be readily realized that the functions described for each module 202, 204, 206, 208, 210, 212, 214, 216, or 218 can be performed by executing various code portions which are stored on one or more non-transitory computer-readable media and at predetermined time intervals.

It is also to be understood and appreciated that the execution of the software codes from the non-transitory computer-readable media can be done on appropriate computing hardware and number of computing hardware, and that the modules 202, 204, 206, 208, 210, 212, 214, 216, or 218 of the software 200 are merely segregated based on their intended functions for the sake of illustrating how they are relevant to the implementation of one or more embodiments of the system for providing an advertisement in an interactive environment of the present invention.

The illustrated modules can be fewer or greater in number, as it is well known in the art of computing that such software codes representing various functions of different modules can be combined or segregated in any suitable but efficient manner insofar as software execution is concerned.

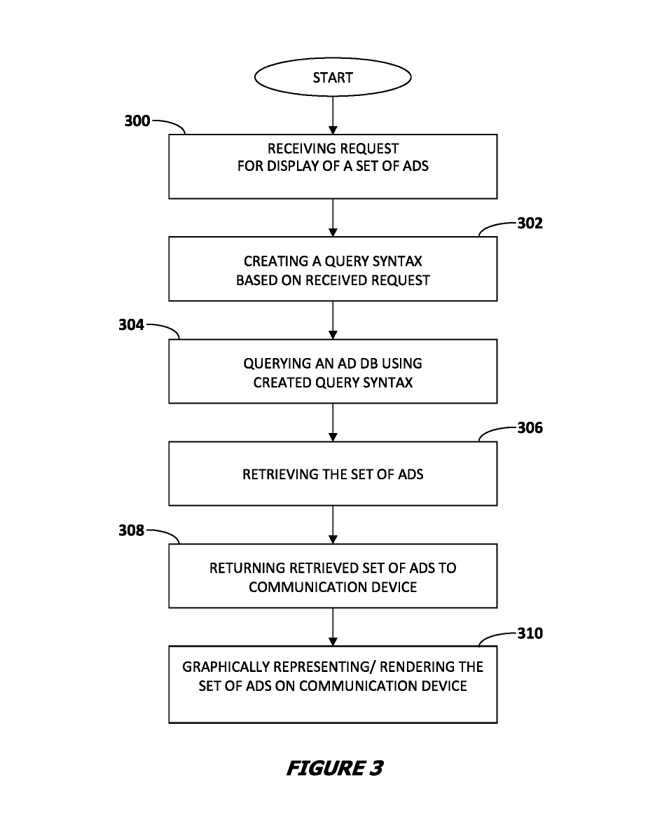

Referring to FIG. 3, there is shown a general flow diagram for providing an advertisement suitable use in the system of FIG. 1 according to one or more embodiments of the present invention. The steps in the illustrated flow diagram may be carried out by a processor described in FIG. 1. The flow starts at block 300 wherein the processor receives a request from a communication device, particularly through a user interface of the communication device, for displaying a set of advertisements on its user interface. On the receipt of the request for the set of advertisements, the processor performs the step of creating a query syntax based on the same request, as shown in block 302, and then the step of querying an advertisement database using the created query syntax, as separately shown in block 304.

The querying of the advertisement database in the previous block 304 causes the flow to move to block 306 wherein the processor retrieves the set of advertisements from the advertisement database. After which, the processor returns the retrieved set of advertisements to the communication device which requested for the display of the same advertisements through its user interface, as shown in block 308. The flow terminates at block 310 wherein the advertisements are graphically represented on the display screen or user interface of the communication device. The graphical representation of the advertisements may be adjusted depending on, or responsive to, the specification of the communication device.

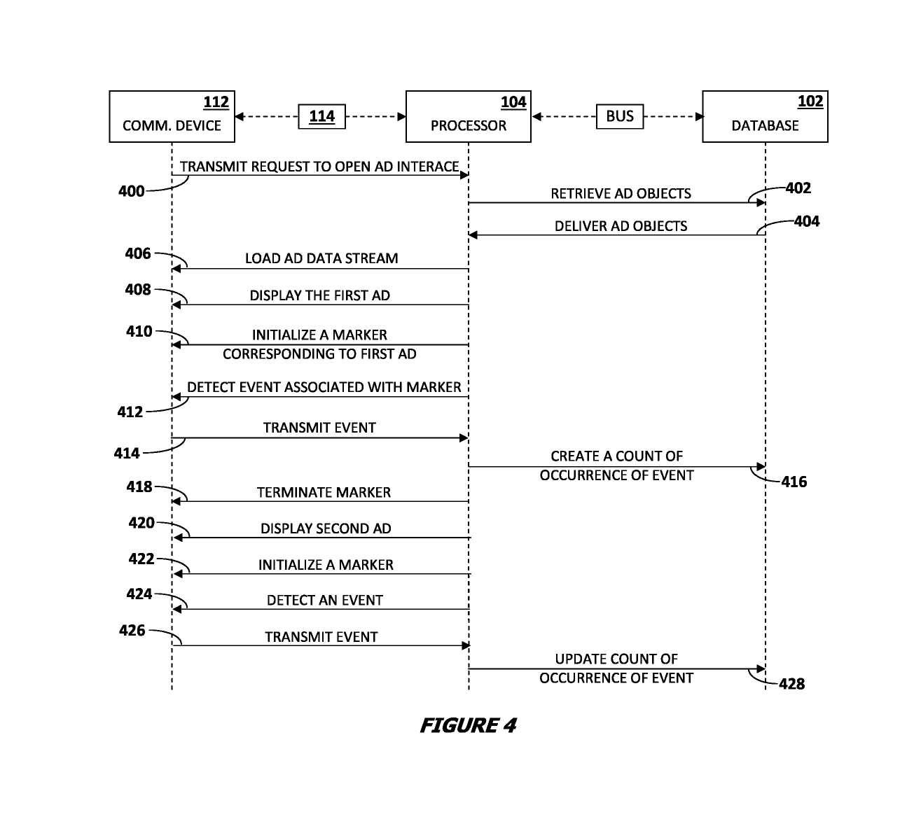

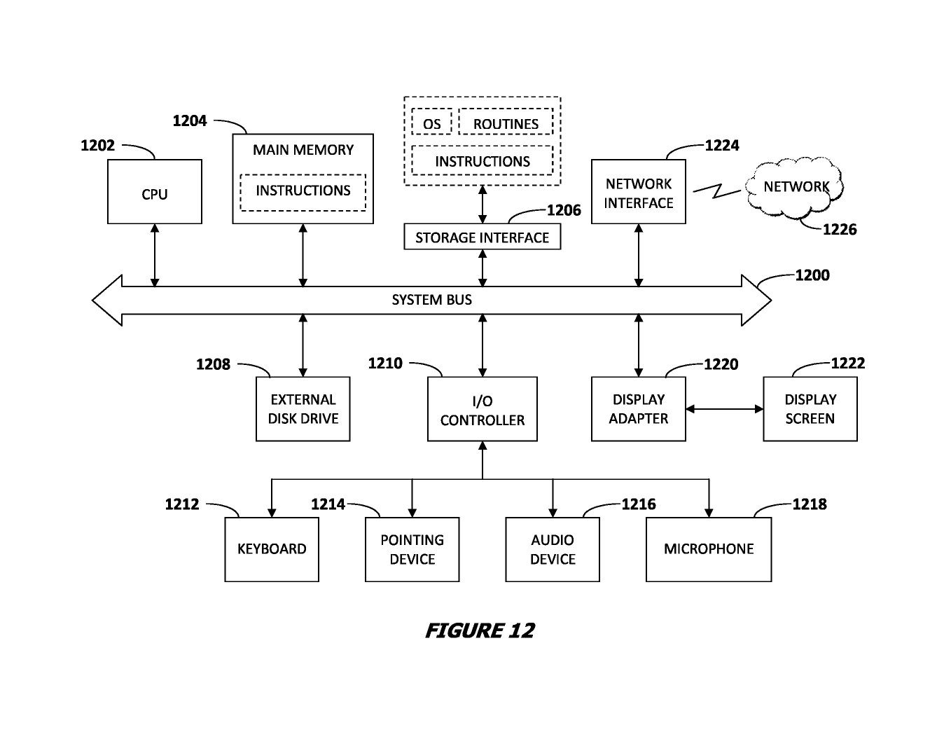

Referring to FIG. 4, there is shown a flow diagram illustrating an interaction of the components of the system of FIG. 1 for measuring quantitative metrics according to one or more embodiments of the present invention. Particularly, the illustrated interaction is made among the communication device 112, the processor 104, and the database 102. The interaction between the communication device 112 and the processor 104 may be effected through the communication network 114. On one hand, the interaction between the processor 104 and the database 102 may be made operable through a system bus which will be described in greater detail in FIG. 12 below. The flow commences when the communication device 112 transmits to the processor 104 a request to open or access an advertisement interface on the user interface of the communication device 112, as shown in path 400.

The flow proceeds to the processor 104, retrieving objects associated with the advertisement from the database 102 as shown in path 402. Subsequently, the flow proceeds to the database 102, delivering the advertisement objects from the database 102 to the processor 104 as shown in path 404. The delivery of the advertisement objects to the processor 104 causes the flow to continue by loading a data stream of advertisements on the user interface of the communication device 112 by the processor 104, as shown in path 406, and then by displaying a first advertisement content associated with the data stream of advertisements on the same user interface by the processor 104, as shown in subsequent path 408.

After the first advertisement content has been displayed, the flow takes path 410, initializing of a marker (i.e., a graphic element) corresponding to the displayed first advertisement by the processor 104. After which, the flow follows path 412 wherein any event associated with the marker is continuously detected by the processor 104. If an event on the user interface of the communication device 112 is detected, the same event is transmitted from the communication device 112 to the processor 104 as shown in path 414.

The detection of the event causes the processor 104 to create a count of the occurrence of the event in the database 102 as shown in path 416. Following a subsequent path 418, the flow continues by the processor 104 terminating the marker displayed on the first advertisement. Consequently, the processor 104 proceeds to display a second advertisement as shown in path 420. Similar to the first advertisement having the marker displayed thereon, the second advertisement is likewise arranged to have an initialized marker as shown in path 422.

Another event on the user interface of the communication device 112 displaying the second advertisement is detected by the processor 104 as shown in path 424 and transmitted to the processor 104 from the communication device 112 as shown in path 426. The transmitted event from the communication device 112 to the processor 104 triggers the processor 104 to update the count of the occurrence of the event in the database 102 as shown in path 428.

A third advertisement, fourth advertisement, fifth advertisement, and so forth, may be displayed on the user interface of the communication device 112 by the processor 104. The same flow in paths 422, 424, 426, and 428 may be performed by the processor 104 in respect of each of the subsequent advertisements displayed on the user interface of the communication device 112 by the processor 104.

The loop from path 420 to 428 means that for the entire data stream of advertisements, a value corresponding to the total number of count of occurrence of the event effected on the user interface of the communication device 112 relative to each of the advertisements included in the data stream of advertisements may be determined. This value is the one associated with the second user interaction data described in full detail in FIG. 1.

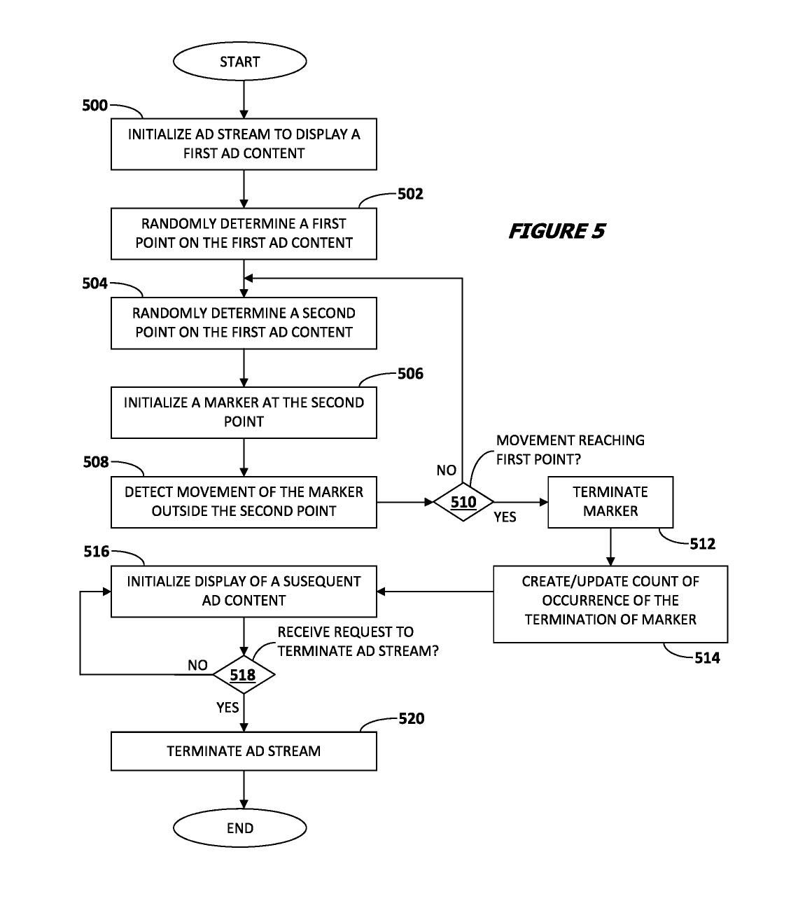

Referring to FIG. 5, there is shown a flow diagram illustrating a process for detecting an event suitable for use in the flow of FIG. 3 according to one or more embodiments of the present invention. The process in FIG. 5 may suitably be carried out by the processor described in full detail in FIG. 1, and starts at block 500 wherein a data stream of advertisements is initialized to display a first advertisement content on a user interface. The process subsequently advances to block 502 wherein a first point on the first advertisement content is determined, and then to block 504 wherein a second point on the first advertisement content is determined. The determination of the first and second points on the first advertisement content is preferably carried out in a random fashion. On the determination of the first and second points, the process moves to block 506 wherein a marker is initialized at the second point, causing the marker to be rendered on the portion of the user interface at which the second point is located.

During the whole time within which the marker is rendered on the user interface, its movement outside the second point or an area defined by the second point is detected as shown in block 508. If such movement is detected to have reached the first point or an area of the first advertisement content defined by the first point as determined in decision block 510, the marker is immediately terminated as shown in block 512. Otherwise, the process moves back to the previous block 504 wherein a new second point on the first advertisement content is randomly determined. As long as the movement of the marker, as detected in the decision block 510, does not reach the first point or the area of the first advertisement content defined by the first point, a loop is created from the previous block 504 to the decision block 510.

The termination of the marker as shown in the previous block 512 causes creation or updating of count of occurrence of the termination of the marker as shown in block 514. After which, the process moves to block 516 wherein a display of subsequent advertisement content included in the data stream of advertisements is initialized. As long as no request to terminate the advertisement stream is received as determined in decision block 518, the process performs the action steps in previous blocks 502, 504, 506, 508, 510, 512, 514, and 516. Otherwise, if such request to terminate the data stream of the advertisements is received as determined in the previous decision block 518, then the process concludes at block 520, wherein the data stream of the advertisements is so terminated.

It is to be understood and appreciated that the step of creating or updating the count of the occurrence of the termination of marker, as it merely illustrates an embodiment of the present invention, may be replaced by other suitable mechanisms. For example, in place of counting the termination of each marker appearing in one data stream of the advertisements, the moment when the marker leaves the second point and reaches the first point may be counted. It is likewise possible to count the initialization of the display of every subsequent advertisement content included in the data steam of advertisements as shown in the previous block 516, as change in the advertisement content may be readily taken to indicate the termination of marker as shown in the previous block 512.

Any of such events may be suitably used for determining the value associated with the second dataset representing quantitative metrics indicative of a measure of the second user interaction data, wherein the value determines whether an access to a virtual game environment providing a virtual game of chance which can be played to win a real-world prize, and wherein the access to the virtual game of environment can be represented by an electronic lottery ticket, all of which are described in great detail in FIG. 1.

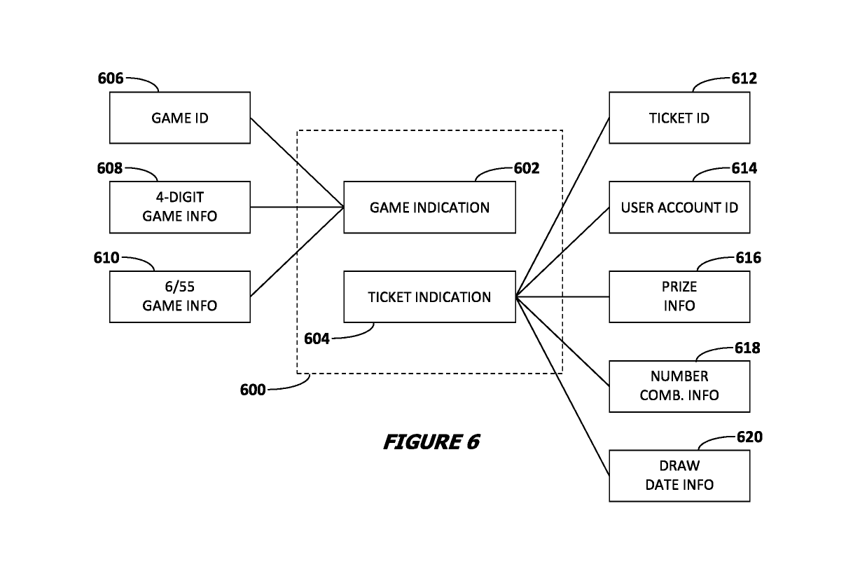

Referring to FIG. 6, there is shown a block diagram of components of an electronic lottery ticket of FIG. 5 according to one or more embodiments of the present invention. The electronic lottery ticket 600 has a game indication 602 and a ticket indication 604. The game indication 602 corresponds to a selection of available games characterized by games of chances that can be played by a participating user. The games of chances may be of the lottery type such as 6/42, 6/45, 6/49, 6/55, 6/58, 4 Digit, 6 Digit, and EZ2 lotto, and the conduct of each of which may be made similar to the conduct of their respective real-world counterparts offered, for example, by the Philippine Charity Sweepstakes Office (PCSO) or any other similar institutions authorized to generate revenue through lotteries or various types of number games. The gameplays in the virtual game environment of the present invention may or may not be governed by such institutions or national laws. Preferably, the game indication 602 includes a game identifier 606, a 4-digit game information 608, and a 6/55 game information 610.

The ticket indication 604 may be an access code or a serial number that can be read by the system described in FIG. 1. Embedded in the ticket identifier 604 are some key information such as the specific lottery game in which it can be used, the user account to which it belongs, the user information associated with the user account, and the combination of numbers assigned to it once the user has designated a series of numbers in accordance with the type of lottery gameplay. The access code or the serial number embodying the ticket identifier 604 may or may not be displayed on the user interface on which the lottery game in the virtual game environment can be accessed. Preferably, as illustrated, the ticket indication 604 may include ticket identifier 612, user account identifier 614, prize information 616, number combination information 618, and draw date information 620.

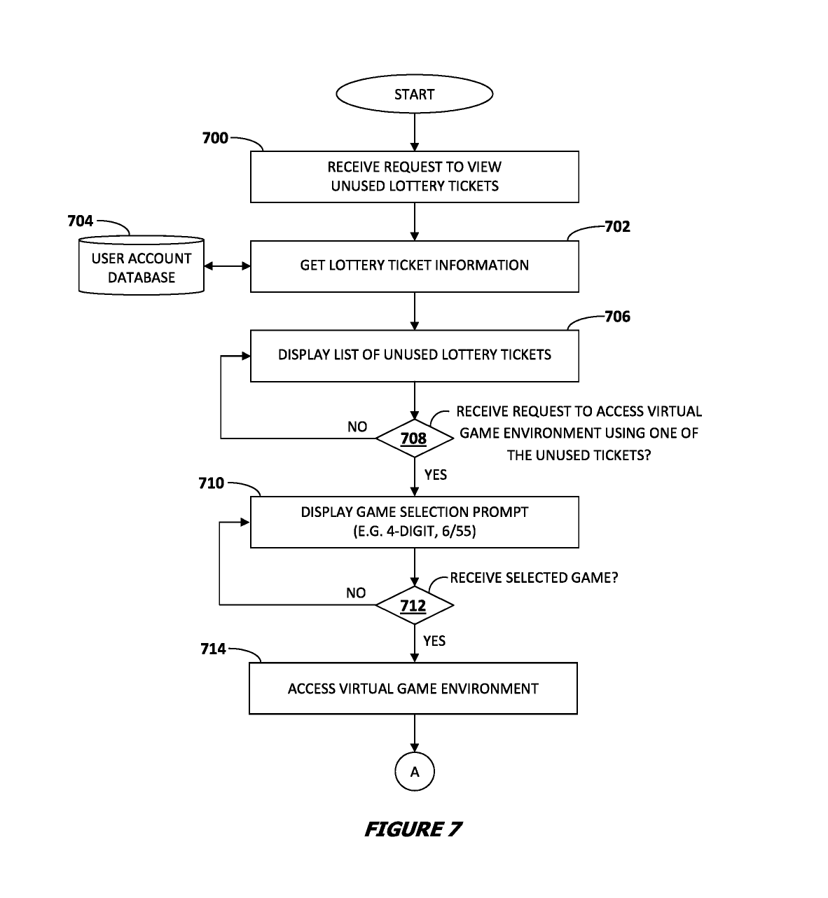

Referring to FIG. 7, there is shown a flow diagram of a process for accessing a virtual game environment suitable for use in the system of FIG. 1 according to one or more embodiments of the present invention. In particular, the illustrated process in FIG. 7 shows accessing the virtual game environment using the electronic lottery ticket fully described in FIGS. 5 and 6, and may be performed by the processor described in FIG. 1. The process commences at block 700 wherein the request to view on a user interface some unused electronic lottery tickets are received. This initial step triggers the process to move to block 702 wherein the lottery ticket information associated with the electronic lottery tickets are obtained from a lottery database 704. At subsequent block 706, the list of the unused lottery tickets is displayed on the user interface.

At decision block 708, the request to access the virtual game environment using any one of the electronic lottery tickets is received. If such request is not received, the process may continue to display list of unused lottery tickets as shown in the previous block 706. On the other hand, receipt of such request triggers the process to progress to block 710 wherein the game selection prompt may be displayed. The game selection prompt includes all types of lottery games (e.g., 4 digit, 6/55) that can be played by the user in order to potentially win a real-world prize such as a cash prize. Any one of the lottery games can be selected by the user so that he/she can engage with a gameplay based on his/her selection. If a particular lottery game is selected by the user as determined in decision block 712, then the processor moves to access the virtual game environment as shown in concluding block 714. Otherwise, the process may continue to display the game selection prompt as shown in the previous block 710.

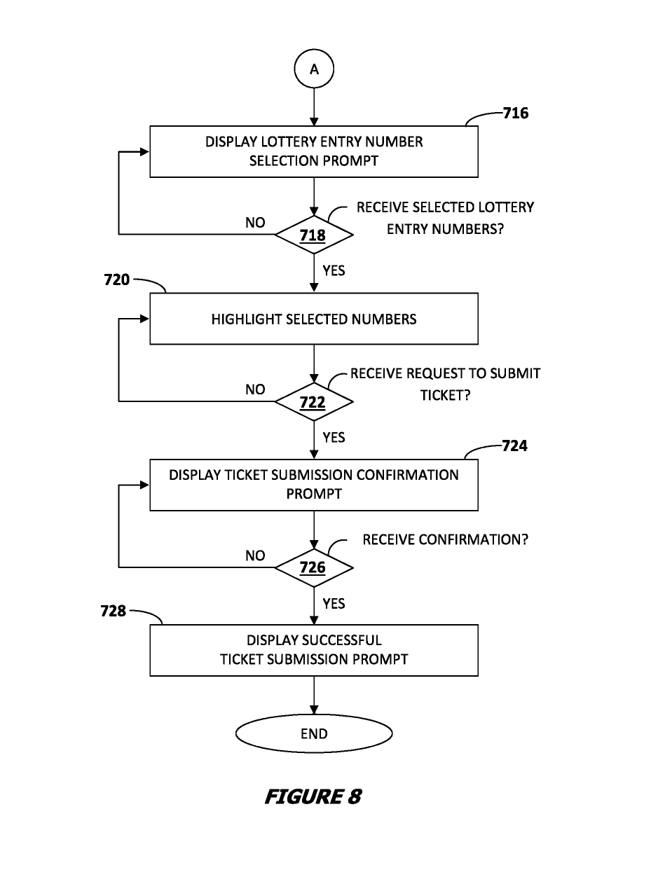

Referring to FIG. 8, there is shown a continuation of the flow diagram of FIG. 7. The continuation point is marked by encircled letter “A.” At block 716, a lottery entry number selection prompt is displayed. The display of this prompt enables the user to manually select a number combination based on the type of lottery game. For example, if the lottery game is a 6/55 lotto game, then a set of fifty-five (55) numbers may form part of the displayed prompt from which the user can select five numbers to form a lottery entry. Apart from the manual selection of numbers, an automatic selection of numbers may also be carried out by way of activating a random number generator. Once the selected lottery entry numbers are received as shown in decision block 718, the process moves to highlight the same lottery entry numbers as shown in block 720. Otherwise, the process may continue to display the lottery entry number selection prompt as shown in the previous block 716.

The highlighted lottery entry numbers may serve to indicate that the electronic lottery ticket associated with them is ready to be submitted. If a request to submit the electronic lottery ticket containing the highlighted lottery entry numbers is received as determined in decision block 722, then the process progresses to block 724 wherein a ticket submission confirmation prompt is displayed. Otherwise, the process may continue to highlight the lottery entry numbers as shown in the previous block 720. If a confirmation is received in response to the display of the ticket submission confirmation prompt as determined in decision block 726, then the process concludes at block 728 wherein a successful ticket submission prompt is displayed. Otherwise, the process may continue to display the ticket submission confirmation prompt as shown in the previous block 724.

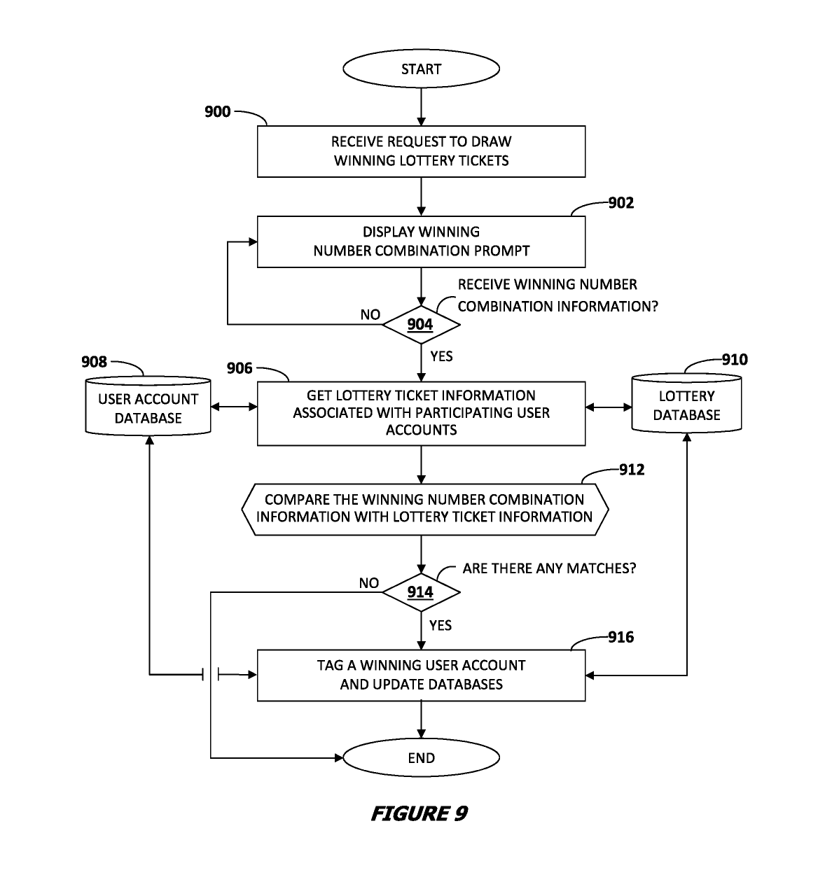

Referring to FIG. 9, there is shown a flow diagram illustrating a process for conducting an electronic lottery draw suitable for use in the system of FIG. 1 according to one or more embodiments of the present invention. The illustrated process in FIG. 9 may be performed by the processor fully described in FIG. 1. The process starts with receiving a request to draw winning electronic lottery ticket as shown in block 900, followed by displaying winning number combination prompt as shown in block 902.

At decision block 904, the process determines whether a winning number combination information is received. The receipt of the winning number combination information may be effected by an administrator of the lottery game corresponding to the electronic lottery draw. Alternatively, the receipt of the winning number combination information may be automatically effected through an application programming interface (API) which will be discussed in greater detail in the ensuing description.

If the winning number combination information is not received in the decision block 904, the process may continue to display the winning number combination prompt as shown in the previous block 902. On the other hand, a successful receipt of the winning number combination information may cause the process to advance to block 906 wherein lottery ticket information associated with the participating user accounts are obtained from a user account database 908 and a lottery database 910. After obtaining the lottery ticket information which may contain number combinations belonging to the participating user accounts, the process immediately compares the winning number combination information with the lottery ticket information, particularly with each of the number combinations contained in the lottery ticket information, as shown in block 912.

At decision block 914, the process determines if the winning number combination information matches with any one or more of the number combinations contained in the lottery ticket information. If there is at least one match, then the process moves to block 916 to tag a winning user account having the winning number combination and to update the user account database 908 and the lottery database 910 accordingly. Otherwise, the process may be terminated.

Referring to FIG. 10, there is shown a flow diagram illustrating a process for applying a winning eligibility criterion suitable for use in the system of FIG. 1 according to one or more embodiments of the present invention. The illustrated process in FIG. 10 may be performed by the processor fully described in FIG. 1. The process starts with determining whether a request to access the system resources in FIG. 1 is received from a user registered or otherwise not registered with the system as shown in decision block 1000. If the user is not registered, the process proceeds to block 1002 wherein a user registration prompt is displayed and, subsequently, to block 1004 wherein a user account is created based on user information provided on the user registration prompt and the user information are stored in a user account database 1006.

In any of the two instances in which the user account has been created in the previous block 1004 and in which the user has already been registered as determined in the decision block 1000, the process may proceed to block 1008 wherein a user login prompt is displayed and then to block 1010 wherein the user login credential information are validated. The required user login credential information may include, for example, email information and password information. If the email and password information are invalid as determined in decision block 1012 by consulting the user account database 1006, the process moves to block 1014 wherein an invalid user login credentials prompt is displayed. At this point, the process may continue to move to block 1008 wherein the user login prompt is displayed.

If, on the other hand, the email and password information are valid as determined in the decision block 1012, the process advances to block 1016 wherein the user profile page may be initialized and displayed and then to block 1018 wherein the prize draw (i.e., winning) eligibility criteria selection prompt is displayed. The winning eligibility criteria may be implemented in one or more embodiments of the present invention by way of, for example, requiring electronic declarations of real-world documents or events associated with the users.

In one embodiment, it is preferable to require the following electronic declarations: (i) birth certificate; (ii) bank account; (iii) passport with at least one (1) immigration stamp; (iii) 2005 model car or newer; (iv) Visa™ or Mastercard™ with credit limit of at least 200,000.00 Philippine Peso or about 4,500.00 U.S. Dollars; (v) Visa™ or Mastercard™ with credit limit of at least 500,000.00 Philippine Peso or about 11,200.00 U.S. Dollars; (vi) real estate property with zonal worth of at least 200,000.00 Philippine Peso or about 4,500.00 U.S. Dollars; and (vii) real estate property with zonal worth of at least 10,000,000.00 Philippine Peso or about 225,000.00 U.S. Dollars.

The abovementioned electronic documents, when declared by the users, must be presented to the service provider of the system of the present invention at the time that they claim any of the real-world prizes they have won. False declarations may cause forfeiture of the real-world prizes. There are many notable advantages for implementing the declaration of the electronic documents which may support the financial capacity of the users. The most basic advantage is that fraud or misrepresentations can be prevented. Another is that, particularly on the part of the advertisers, the data stream of advertisements may be targeted according to the socio-economic status and/or interest of each participating user. For example, if the system receives a declaration from one particular user that he/she has a passport with at least one (1) immigration stamp, then the data stream of the advertisements may be made relevant to that declaration. In the given example, the data stream of advertisements may include advertisements on travels, tours, and accommodations.

If one of the electronic declarations (i.e., proof of prize draw eligibility criteria information) is received as shown in decision block 1020, then the process moves to concluding block 1024 wherein the submitted electronic declaration may be stored in the user account database 1006. Otherwise, the process may continue to display the prize draw eligibility criteria selection prompt as shown in the previous block 1018. It is to be understood and appreciated that it is likewise possible to require uploading of copies of electronic documents corresponding to the aforesaid electronic declarations, and that any uploaded electronic documents may be stored in the user account database 1006 for more expedited verification or authentication of any declaration of any winning user accounts owned by the participating users.

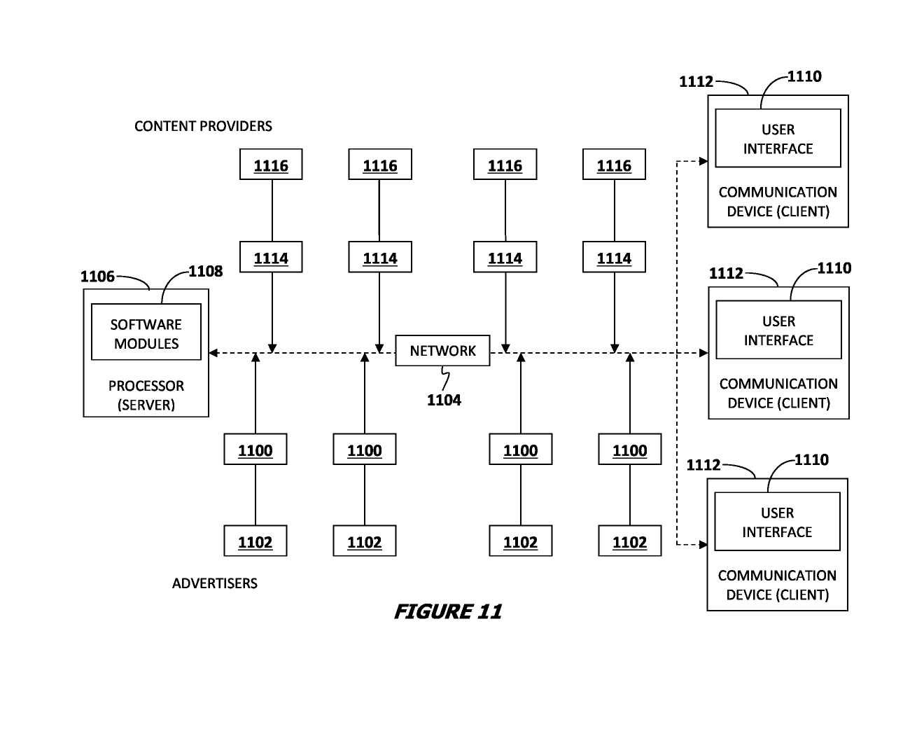

Referring now to FIG. 11, there is shown a block diagram illustrating an alternative system for providing an advertisement in an interactive environment according to one or more embodiments of the present invention. In the system of FIG. 1, the presentation of the data stream of advertisements on the user interface of the communication device is locally arranged in the processor. In the alternative system of FIG. 11, such presentation of the data stream of advertisements 1100 may be made to originate from advertiser's remote hardware and software resources 1102 on the web through application programming interfaces (APIs) through a communication network 1104 embodied by the Internet. This arrangement enables the advertisers to directly feed the data stream of advertisements to the processor 1106 having software modules 1108 acting as a server which, in turn, are displayed, through the communication network 1104, on the user interfaces 1110 of the communication devices 1112 acting as clients.

Third party contents 1114 may likewise be provided to the processor 1106 and, in turn, to the communication devices 1112 from hardware and software resources 1116 of third party content providers through the communication network 1104. Examples of the third party contents 1114 may include, by way of examples, time information, weather information, social media information, geographical information, and winning number combination information originating from a conduct of a real-world game of chance.

Referring to FIG. 12, there is shown a hardware architecture suitable for use in the systems of FIGS. 1 and 11 according to one or more embodiments of the present invention. The hardware architecture may include a system bus 1200 that enables communication of the following components: a central processing unit 1202, a main memory 1204 containing computer-executable instructions, a storage interface 1206 for storing an operating system, routines and instructions, an external disk drive 1208, input/output controller 1210 connected with a keyboard 1212, a pointing device 1214, an audio 1216 and a microphone 1218, a display controller 1220 connected with a display screen 1222, and a network interface 1224 for enabling data communication with other devices over the communication network 1226.

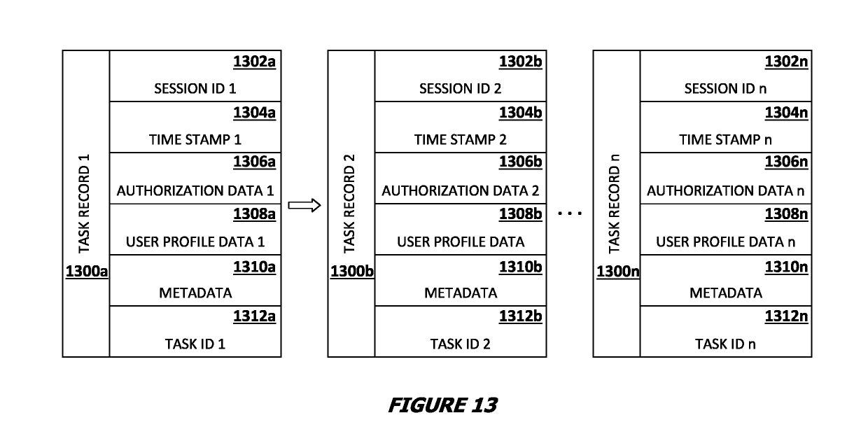

Referring to FIG. 13, there is shown a block diagram of database content suitable for use in the systems of FIGS. 1 and 11 according to one or more embodiments of the present invention. The database content may be characterized by a task record 1300a which may include session identifier 1302a, time stamp 1304a, authorization data 1306a, user profile data 1308a, metadata 1310a, and task identifier 1312a. Multiple task records 1300a, 1300b, 1300n may be created in the database fully described in FIG. 1 in response to a request for accessing the same database by any communication device.

The task records may be updated, deleted, or used, by way of examples, for identifying the plurality of datasets representing advertisements, quantitative metrics and a virtual game environment and as well as the first, second, and third user interaction data, all of which are described in great details in FIG. 1. The task record 1300b may include session identifier 1302b, time stamp 1304b, authorization data 1306b, user profile data 1308b, metadata 1310b, and task identifier 1312b. Every task record 1300n may likewise include session identifier 1302n, time stamp 1304n, authorization data 1306n, user profile data 1308n, metadata 1310n, and task identifier 1312n.

In another aspect of the present invention, there is provided a method (not illustrated) for providing an advertisement in an interactive environment. The method is preferably computer-implemented.

A first step of the method is characterized by obtaining a first dataset representing at least one advertisement from a database in response to first user interaction data received from a communication device through a user interface of the communication device, wherein a representation of the first dataset is rendered on the user interface of the communication device.

A second step of the method is characterized by generating and storing into the database a second dataset representing quantitative metrics indicative of one or more measures of at least one second user interaction data received from the communication device through the user interface on which the representation of the first dataset is rendered.

A third step of the method is about providing an access to a third dataset representing a virtual game environment based on at least one value associated with the second dataset, the third dataset having at least one indicia indicative of a real-world prize.

A fourth step of the method is the attribution of an indicia to a user account stored in the database based on third user interaction data received from the communication device through the user interface on which a representation of the third dataset is rendered.

The step of attributing the indicia to the user account may be based further on an outcome of a virtual game of chance included in the virtual game environment represented by the third dataset. The method may also include the step of determining the outcome of the virtual game of chance based on a fourth dataset derived from a conduct of a real-world game of chance equivalent to the virtual game of chance.

1. A computer-implemented system for providing an advertisement in an interactive environment, the system comprising:
a database for identifying and storing a plurality of datasets;
a processor in operative communication with the database and arranged to render representations of the plurality of datasets from the database on a user interface of a communication device; and
computer-executable instructions stored on a computer-readable medium in operative communication with the processor and which, when executed by the processor from the computer-readable medium, are arranged to
obtain a first dataset associated with the plurality of datasets and representing at least one advertisement from the database in response to at least one first user interaction data received from the communication device through the user interface, a representation of the first dataset being rendered on the user interface of the communication device,
generate and store into the database a second dataset associated with the plurality of datasets and representing quantitative metrics indicative of one or more measures of at least one second user interaction data received from the communication device through the user interface on which the representation of the first dataset is rendered, and
provide an access to a third dataset associated with the plurality of datasets and representing a virtual game environment based on at least one value associated with the second dataset, the third dataset having at least one indicia indicative of a real-world prize, wherein the at least one indicia can be attributed to a user account stored in the database based at least on at least one third user interaction data received from the communication device through the user interface on which a representation of the third dataset is rendered.

2. The system according to claim 1, wherein the virtual game environment represented by the third dataset includes at least one virtual game of chance.

3. The system according to claim 2, wherein the indicia can be attributed to a user account owned by the user based further on an outcome of the virtual game of chance.

4. The system according to claim 3, wherein the outcome of the virtual game of chance is determined based on a fourth dataset associated with the plurality of datasets and introduced from a conduct of a real-world game of chance equivalent to the virtual game of chance.

5. The system according to claim 1, wherein the at least one value associated with the second dataset representing the quantitative metrics corresponds to a total number of advertisements that are opened through the user interface on which the representation of the first dataset is rendered.

6. The system according to claim 1, wherein the at least one value associated with the second dataset representing the quantitative metrics corresponds to a total number of clickable links in one or more of the advertisements clicked on the user interface on which the representation of the first dataset is rendered.

7. The system according to claim 6, wherein each of the clickable links is embedded on the advertisement represented by the first dataset.

8. The system according to 6, wherein each of the clickable links is embedded on at least one graphic element corresponding to the first dataset rendered on the user interface.

9. The system according to claim 8, wherein the graphic element is selected from any of the following: a still image and a moving image.

10. The system according to claim 9, wherein the graphic element is moveable within an area of the user interface defined by the first dataset rendered on the user interface.

11. The system according to claim 10, wherein a movement of the graphic element from one portion of the area of the user interface to another causes change in the advertisement represented on the user interface by the first dataset.

12. The system according to claim 11, wherein the graphic element is arranged to appear on the user interface on which the representation of the first dataset is rendered after a predetermined time period for each change in the advertisement.

13. A computer-implemented method for providing an advertisement in an interactive environment, the method comprising:
obtaining a first dataset representing at least one advertisement from a database in response to at least one first user interaction data received from a communication device through a user interface of the communication device, wherein a representation of the first dataset is rendered on the user interface of the communication device;
generating and storing into the database a second dataset representing quantitative metrics indicative of one or more measures of at least one second user interaction data received from the communication device through the user interface on which the representation of the first dataset is rendered;
providing an access to a third dataset representing a virtual game environment based on at least one value associated with the second dataset, the third dataset having at least one indicia indicative of a real-world prize; and
attributing at least one indicia to a user account stored in the database based at least on at least one third user interaction data received from the communication device through the user interface on which a representation of the third dataset is rendered.

14. The method according to claim 13, further comprising attributing the indicia to the user account based further on an outcome of a virtual game of chance included in the virtual game environment represented by the third dataset.

15. The method according to claim 14, further comprising determining the outcome of the virtual game of chance based on a fourth dataset derived from a conduct of a real-world game of chance equivalent to the virtual game of chance.
